(19) United States
(12) Patent Application Publication
(10) Pub. No.: US 2007/0141456 A1
(43) Pub. Date: Jun. 21, 2007

(54) Bipolar membrane

(75) Inventors: Shengxian Wang, Shanghai (CN); Chang Wei, Niskayuna, NY (US); Qunjian Huang, Shanghai (CN); Hai Yang, Shanghai (CN); Dong Wang, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/314,910

(22) Filed: Dec. 21, 2005

(51) Int. Cl. H01M 2/16; H01M 8/10; H01M 12/06; H01M 4/94; H01M 4/96; H01M 4/58

(52) U.S. Cl. 429/144; 429/30; 429/27; 429/33; 429/44; 429/218.2

(57) ABSTRACT

The embodiments of the present invention relate to a membrane assembly for use in a galvanic cell, the membrane assembly comprising an anionic layer in contact with an electrolyte base, a cationic layer in contact with an electrolyte acid and an intermediate layer separating the anionic layer and cationic layer.

### FIELD OF TECHNOLOGY

Embodiments of the invention may relate to a bipolar membrane for use in a fuel cell or battery. Particularly, embodiments may relate to a bipolar membrane for use in a rechargeable fuel cell or metal/air battery.

### BACKGROUND

A fuel cell may convert the chemical energy of a fuel directly into electricity without any intermediate thermal or mechanical processes. Energy may be released when a fuel reacts chemically with oxygen in the air. A fuel cell may convert hydrogen and oxygen into water. The conversion reaction occurs electrochemically and the energy may be released as a combination of electrical energy and heat. The electrical energy can do useful work directly, while the heat may be dispersed.

Fuel cell vehicles may operate on hydrogen stored onboard the vehicles, and may produce little or no conventional undesirable by-products. Neither conventional pollutants nor green house gases may be emitted. The byproducts may include water and heat. Systems that rely on a reformer on board to convert a liquid fuel to hydrogen produce small amounts of emissions, depending on the choice of fuel. Fuel cells may not require recharging, as an empty fuel canister could be replaced with a new, full fuel canister.

Metal/air batteries may be compact and relatively inexpensive. Metal/air cells include a cathode that uses oxygen as an oxidant and a solid fuel anode. The metal/air cells differ from fuel cells in that the anode may be consumed during operation. Metal/air batteries may be anode-limited cells having a high energy density. Metal/air batteries have been used in hearing aids and in marine applications, for example.

Metal/air batteries have been used as a primary battery due to the limited recharging ability of the metal anode. This issue was partly resolved by replacing the metal anode with a metal hydride, which led to a new type of metal air battery, or rechargeable fuel cell, as described in WO 2005/008824.

In a rechargeable fuel cell, the electrolyte may be a base solution, such as a potassium hydroxide aqueous solution. The anode materials, for example metal hydride, can be stabilized in such a base solution. Because potassium hydroxide solution is a strong base, it may react with carbon dioxide in air to form a carbonate. Air may contain about 380 ppm carbon dioxide. Carbonate formation may reduce the pH and/or conductivity of the potassium hydroxide solution. The potassium carbonate may deposit within pores of the cathode to block the passage of air therethrough. The effect of carbonate formation and deposition may be referred to as CO₂ poisoning. To address the problem, the exposure area to air of the cathode has been reduced in an attempt to prolong the cathode life. Another approach has been to use a CO₂ scrubber. The scrubber may be filled with lime to absorb CO₂ from the air prior to contacting the air to the cathode. Such a scrubber may require periodic maintenance and/or replenishment. Other approaches may include periodically adding fresh potassium hydroxide to the circulation of potassium hydroxide solution within a galvanic cell.

It may be desirable to have a fuel cell and/or a metal/air battery having differing characteristics or properties than those currently available.

### BRIEF DESCRIPTION

The embodiments of the present invention relate to a membrane assembly for use in a galvanic cell, the membrane assembly comprising an anionic layer in contact with an electrolyte base, a cationic layer in contact with an electrolyte acid and an intermediate layer separating the anionic layer and cationic layer.

### DESCRIPTION OF THE DRAWINGS

Embodiments of the invention may be best understood by referring to the following description and accompanying drawings, which illustrate such embodiments. The numbering scheme for the Figures included herein are such that the leading number for a given reference number in a Figure is associated with the number of the Figure. Reference numbers are the same for those elements that are the same across different Figures. In the drawings:

FIG. 1 illustrates a perspective view depicting a rechargeable fuel cell with bipolar membrane as a separator, according to some embodiments of the invention.

FIG. 2 illustrates an exploded view depicting a bipolar membrane structure, according to some embodiments of the invention.

### DETAILED DESCRIPTION

Embodiments of the invention may relate to a bipolar membrane for use in a fuel cell or battery. Particularly, embodiments may relate to a bipolar membrane for use in a rechargeable fuel cell or metal/air battery.

References in the specification to “one embodiment”, “an embodiment”, “an example embodiment,” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

According to an embodiment of the invention, a bipolar membrane is incorporated in a rechargeable fuel cell or metal/air battery. The bipolar membrane may function to reduce carbon dioxide poisoning of the cathode. As used herein, bipolar membrane is a composite membrane combining a cationic membrane and anionic membrane with an intermediate layer disposed between the cationic membrane and the anionic membrane in an electrical cell. The bipolar membrane may function as a separator in an electrical cell. The electrical cell may be part of a rechargeable fuel cell or an air/metal battery.

The bipolar membrane may define an ion-conducting pathway between an acid solution and a base solution in an electrical cell. Particularly, the bipolar membrane can separate electrolytes within the electrical cell. This separation configuration may allow the base solution to contact the anode, and the acid solution to contact with the cathode, and the cathode to contact air. By disposing the acid media on the cathode side, the carbon dioxide in the air may be separated from the alkaline electrolyte. Particularly, the carbon dioxide cannot react with, or CO₂ poison, the cathode because carbonate formation is reduced or precluded.

Suitable acid electrolytes may include those acids that have a low vapor pressure. Phosphorus acid is a suitable acid that has a relatively low vapor pressure. Liquid organic acids may be used, as those may have a relatively low vapor pressure. The bipolar membrane may reduce the water evaporation rate for such devices when using an acid with a low vapor pressure.

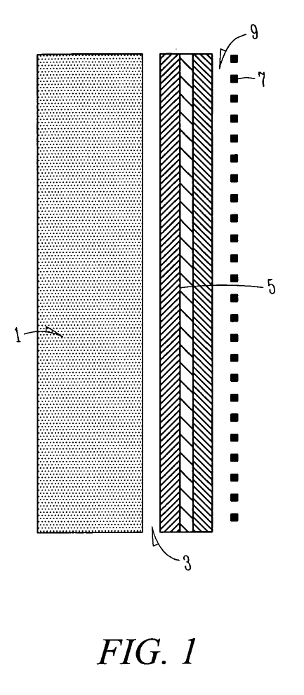

One embodiment of the invention, illustrated in FIG. 1, includes a fuel cell assembly that includes an anode 1, a bipolar membrane 5, and a cathode 7. The bipolar membrane 5 is disposed between the cathode 7 and the anode 1. An acid layer 9 and a base layer 3 each adjoins, contacts, and faces a respective surface of the bipolar membrane 5.

In addition to the respective surface of the bipolar membrane 5, the acid layer 9 and the base layer 3 are each in contact with one of the electrolytes. During operation, the use of a low vapor pressure acid at the acid layer 9 may reduce or prevent evaporation of water. The use of the acid layer 9 and the base layer 3 may reduce or inhibit the creation and/or deposition of carbonate from the reaction of base electrolyte and carbon dioxide in the ambient air. The electrolyte present at the acid layer 9 is referred to as acid electrolyte, and as base electrolyte when in contact with the base layer 3.

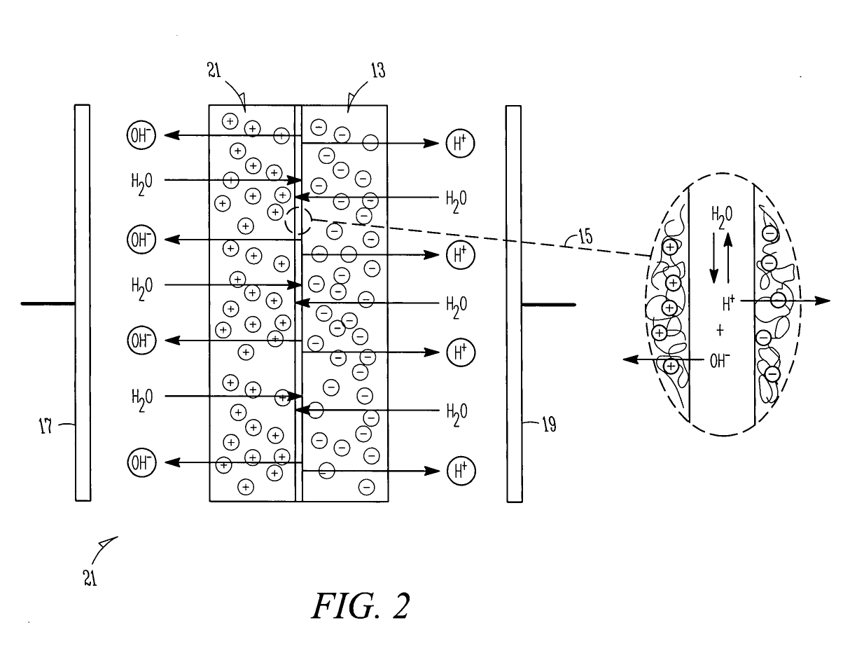

An exploded view having a bipolar membrane structure is shown in FIG. 2. The bipolar membrane structure 21 may include an anionic layer 11 adjacent to a cathode 19, a cationic layer 13 adjacent to an anode 17, and an intermediate layer 15 separating the anionic layer 11 and cationic layer 13. In FIG. 2, the rechargeable fuel cell is in a state of discharge. During this operation, arrows show the movement, migration or flow of protons, hydroxyl ions, and water molecules.

Referring to FIGS. 1 and 2, the bipolar membrane 5 is usable as a separator between an anode 1 and cathode 7 in a galvanic cell. The galvanic cell may be a fuel cell, such as a rechargeable fuel cell. A suitable rechargeable fuel cell may be an alkaline fuel cell with metal hydride as the anode, and with an air electrode as cathode, while in a discharging state. The galvanic cell may also be a battery, such as a metal/air battery. A suitable metal/air battery may be a primary battery (single discharge) or a secondary metal/air battery (rechargeable).

In one embodiment, a primary acid fuel cell may use an acid electrolyte. Suitable acid electrolytes may include one or more of phosphoric acid, nitric acid, sulfuric acid, or an organic acid. The bipolar membrane may be disposed between the acid electrolyte and the metal fuel. Suitable metal fuels may include, for example, zinc, iron, aluminum or a metal hydride. The bipolar membrane structure may comprise an anionic layer, cationic layer, and an intermediate layer. The anionic layer may be selective to and conduct anions. The cationic layer may be selective to and conduct cations. An intermediate layer may separate, space, or electrically insulate the anionic layer from the cationic layer.

The anionic layer may include a polymer that has functional groups that have a base characteristic or are basic. For example, a suitable anionic layer may have one or more pendant base groups such as —NH₂, ═NH, ≡N, or combinations of two or more thereof. A suitable the anionic layer may have pendant quaternary groups. Suitable quaternary groups may include one or more of quaternary ammonium, quaternary sulfonium, quaternary phosphonium, quaternary arsonium, quaternary antimonium, or quaternary hydrosulfide groups.

The cationic layer may include a polymer having functional groups acidic character or are acid. Suitable acid groups may include those derived from one or more of sulfonic acids, carboxylic acids, phosphonic acids, hydroxyl groups or mixtures of two or more thereof.

The polymer substrate for the anionic layer, for the cationic layer, or for both layers may include one or more of polystyrene, polyvinylidene, poly (styrene-divinylbenzene), polyether imide, polycarbonate, polysulphone, polyphenylene oxide, polyamide, polyvinylchloride, polyethylene, polypropylene, mixtures of two or more thereof, or halogenated derivatives thereof. Suitable polyvinylidene halides may include one or both of polyvinylidene fluoride or polyvinylidene fluoride-co-hexafluoropropylene.

A suitable intermediate layer may be an inner layer disposed between the cationic layer and the anionic layer. The addition of the intermediate layer between the anionic layer and cationic layer may form a relatively low potential drop across the bipolar membrane. Suitable polymers for use in the intermediate layer may include one or more of polyvinyl alcohol, polyethylene glycol, polyvinyl formal, polyamidoamine, polystyrene, porous polycarbonate, and the like, or combinations of two or more thereof.

The system may respond to a positive electric field that is built up across the bipolar membrane structure by electrolyzing water. Particularly, water molecules in communication with at least one electrode may split to generate ions. The generated hydrogen ions and hydroxyl ions may migrate to the electrode of opposing polarity. The potential created thereby may generate electric current.

In one embodiment, rather than a positive electric field, a negative electric field may be used. The negative electric field may be built up across the bipolar membrane. In response to the negative electric field, hydrogen ions and hydroxyl ions migrate to a surface of the intermediate layer to generate water and to cause an electric current flow.

Depending on the direction of reaction and the polarity of the electric potential, the anode and the cathode are reversible or interchangeable with each other. In one embodiment, the electric potential is run in one direction for a period, and then reversed to run in the other direction for a period.

When using a bipolar membrane structure in a rechargeable fuel cell or metal/air battery, the acid layer may be placed on the cationic side of the bipolar membrane proximate to the cathode. The base layer may be placed on the anionic side of the bipolar membrane proximate to the anode. An exemplary acid layer may include phosphoric acid, for example. An exemplary base layer may include potassium hydroxide. The anode materials, such as zinc, iron, or metal hydride may be stable in base solution. By stable, the anode material may be relatively non-reactive to a high-pH solution over time and during use. On the acid or cationic side side, a hydroscopic acid may help retain water.

In one embodiment, a positive electric field may be built up across the bipolar membrane structure, for example, when the rechargeable fuel cell with the bipolar membrane as separator is in the state of discharge. During that operation, water may be split or electrolyzed to generate hydroxyl ions and protons. The generated proton ions and hydroxyl ions may migrate to the metal hydride electrodes (anode) and the protons may move towards the air electrode (cathode). Water may be continually consumed to supply the continual formation and migration of proton ions and hydroxyl ion. To balance osmotic pressure, water molecules may transport to the intermediate layer from both the anode side and from the cathode side. Alternatively, a negative electric field may be built up across the bipolar membrane, for example, when the rechargeable fuel cell with the bipolar membrane as separator is in the state of charge, proton ions and hydroxyl ions may migrate to the intermediate layer. The proton ions and hydroxyl ions may contact each other at, proximate to, or in the intermediate layer to generate water and to cause electricity to flow. With the continual production of water in the intermediate layer, excess water may migrate to both cathode side and anode side to keep the balance of osmosis pressure. Switching back and forth from charging to discharging during the operation of the rechargeable fuel cell, correspondingly, the polarity of anode and cathode may be changed accordingly.

When using a bipolar membrane structure in a rechargeable fuel cell or metal/air battery, an acid layer may be placed on the cationic side of the bipolar membrane, proximate to the cathode. A base layer may be placed on the anionic side of the bipolar membrane, proximate to the anode. The acid layer may include one or more acid, for example phosphoric acid. The base layer may be an alkaline hydroxide, such as potassium hydroxide. Using such a structure, the electrolyte exposed to the air may be an acid at the cathode and may not be subject to interaction with carbon dioxide in the air. Similarly, the electrolyte in contact with the base layer may be a basic solution. The anode materials may be selected so as to be stable in a base solution. Suitable anode materials may include a metal, such as zinc or iron, or may include a metal hydride. In one embodiment, a more hygroscopic acid on the cationic side may increase water-retaining performance relative to using a basic electrolyte, such as potassium hydroxide.

The charging process for rechargeable fuel cell with metal hydride as anode and oxygen electrode as cathode using the bipolar membrane may be depicted as follows:
Anode: 4M+4H₂O+4e→4MH+4OH⁻ E_{0,a}=−0.8V
Cathode: 2H₂O→O₂+4H⁺+4e E_{0,c}=1.229V
Bipolar Membrane: 4H⁺+4OH⁻→2H₂O
Total: 4M+2H₂O→4MH+O₂

The discharging process for rechargeable fuel cell with metal hydride as anode and oxygen electrode as cathode using the bipolar membrane may be as follows:
Anode: 4MH+4OH⁻→4M+4H₂O+4e
Cathode: O₂+4H⁺+4e→2H₂O
Bipolar Membrane: 2H₂O→4H⁺+4OH⁻
Total: 4MH+O₂→4M+2H₂O E₀=2.029V

The cathode, or positive electrode, may be made of a substance that has catalytic activity, catalyzing oxygen to be reduced to a hydroxyl ion. The term cathode applies to the electrode where reduction takes place in which electrons are accepted. The cathode may include an air electrode with a catalyst layer and gas diffusion layer.

The catalyst layer may be made of a catalyst, carbon black and binder. The catalyst may be a metal catalyst, a metal oxide catalyst, or a perovskite catalyst. Suitable catalysts may include one or more of BaTiO₃ or LaCoO₃. Suitable binders may include polyvinylidene fluoride or polytetrafluoroethylene (PTFE). The gas diffusion layer may include carbon black and a binder. Suitable binders may include those listed as suitable for use in the catalyst layer.

The anode, or negative electrode, may be made of a substance that has catalytic activity. The catalytic activity may refer to catalyzing hydrogen or metal to be oxidized to, respectively, a proton or metal oxide.

The term anode applies to the electrode where oxidation takes place, and in which electrons may be lost. For a metal/air battery or rechargeable fuel cell, the anode may function as a fuel. The anode may include a hydrogen storage-based material, such as a metal hydride. Suitable hydrogen storage-based materials may include a metal hydride. A suitable metal hydride may be LaNi₅. Other suitable metal hydrides may include one or more of ZrB₂, TiFe, Mg₂Ni or their derivatives. The anode may be constructed using an active material, such as a metal hydride, a binder and one or more conductive additives. The binder may be a gel mixture of PTFE and carboxymethylcellulose (CMC), for example. A suitable conductive additive may be nickel powder.

The voltage drop across bipolar membrane is a function of the current flowing through the membrane. In low to moderate current range, such as 60 mA/cm², that is fit for most normal applications, the voltage across bipolar membrane may be in the range of about 0.9 volts to about 1 volts, depending on the type of bipolar membrane. Considering the open circuit voltage of the rechargeable fuel cell with bipolar membrane as separator is 2.029 volts, together with some polarization of anode and cathode, the net voltage for the fuel cell may be about 1 volt (V).

The foregoing examples are merely illustrative of some of the features of the invention. The appended clauses are intended to define the invention as broadly as it has been conceived and the examples herein presented are illustrative of selected embodiments from a manifold of all possible embodiments. Accordingly it is Applicants' intention that the appended clauses are not to be limited in definition by the choice of examples utilized to illustrate features of the present invention. As used in the clauses, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and, where not already dedicated to the public, those variations should be construed to be covered in the appended clauses. It is also anticipated that advances in science and technology will make equivalents and substitutions possible that are not now contemplated by reason of the imprecision of language and these variations should also be construed where possible to be covered by the appended clauses.

What is claimed is:

1. A membrane assembly, comprising:
a bipolar membrane, the bipolar membrane comprising,
an anionic layer in contact with an electrolyte base;
a cationic layer in contact with an electrolyte acid; and
an intermediate layer separating the anionic layer from the cationic layer.

2. The membrane assembly of claim 1, wherein membrane assembly is disposed within a rechargeable fuel cell assembly.

3. The membrane assembly of claim 2, wherein the rechargeable fuel cell assembly is an alkaline metal hydride/air fuel cell.

4. The membrane assembly of claim 1, wherein the membrane assembly is disposed within a primary battery.

5. The membrane assembly of claim 4, wherein the battery is a metal/air battery.

6. The membrane assembly of claim 1, wherein the anionic layer or the cationic layer comprises a polymer, and the polymer comprises one or more of polystyrene, poly (styrene-divinylbenzene), polysulphone, polyvinylidene fluoride, polyvinylidene halide, polyphenylene oxide, polyamide, polyvinylchloride, polyether imide, polycarbonate, polyethylene, or polypropylene.

7. The membrane assembly of claim 6, wherein the anion layer comprises one or more pendant basic functional groups.

8. The membrane assembly of claim 7, wherein the basic groups comprise one or more of —NH₂, ═NH, or ≡N.

9. The membrane assembly of claim 7, wherein the basic groups comprise one or more of quaternary ammonium, quaternary sulfonium, quaternary phosphonium, quaternary arsonium, quaternary antimonium, or hydrosulfide groups.

10. The membrane assembly of claim 6, wherein the cationic layer comprises a polymer with acidic functional groups.

11. The membrane assembly of claim 10, wherein the acidic functional groups comprise functional groups derived from sulfonic acids, carboxylic acids, phosphonic acids, hydroxyl groups, or combinations of two or more thereof.

11. The membrane assembly of claim 1, wherein the electrolyte acid is in contact with ambient air.

12. A galvanic cell, comprising:
an anode;
a cathode; and
a bipolar membrane separating the anode and the cathode, the membrane comprising:
an anionic layer in contact with an electrolyte base;
a cationic layer in contact with an electrolyte acid; and
an intermediate layer separating the anionic layer from the cationic layer.

13. The galvanic cell of claim 12, wherein the cathode comprises an air electrode with a catalyst layer and a gas diffusion layer.

14. The galvanic cell of claim 13, wherein the catalyst layer comprises catalyst, carbon black, and a binder.

15. The galvanic cell of claim 14, wherein the catalyst comprises one or more of metal catalyst, metal oxide catalyst, or perovskite catalyst.

16. The galvanic cell of claim 13, wherein the gas diffusion layer comprises carbon black and a binder.

17. The galvanic cell of claim 12, wherein the anode comprises an active material, a binder, and at least one conductive additive.

18. The galvanic cell of claim 17, wherein the active material is a metal hydride.

19. The galvanic cell of claim 12, wherein cationic layer is configured to block air from accessing the electrolyte base.

20. The galvanic cell structure of claim 17, wherein the binder comprises one or both of polytetrafluoroethylene or carboxymethylcellulose.

21. The galvanic cell structure of claim 17, wherein the conductive additive comprises carbonyl nickel powder.

22. An electronic system, comprising:
a membrane assembly, the membrane assembly comprising:
means for providing a positive electrical potential;
means for providing a negative electrical potential; and
means for separating the positive electrical potential means from the negative electrical potential means.

23. The system as defined in claim 22, wherein the positive electrical potential means is capable of interacting with ambient air to provide oxidant for a galvanic cell.
